(19) United States
(12) Patent Application Publication
(10) Pub. No.: US 2026/0167908 A1
(43) Pub. Date: Jun. 18, 2026

(54) SYSTEM AND METHOD FOR YEAST SEPARATION IN ALCOHOLIC BEVERAGE PRODUCTION USING ACOUSTIC TRANSDUCERS

(71) Applicant: Applied Physics, Inc., New York, NY (US)

(72) Inventors: Gianni Martire, New York, NY (US); Ed Rietman, Grantham, NH (US); Matthew C. Ellis, Cape Canaveral, FL (US)

(21) Appl. No.: 19/354,678

(22) Filed: Oct. 9, 2025

Related U.S. Application Data
(60) Provisional application No. 63/705,340, filed on Oct. 9, 2024.

(51) Int. Cl. C12H 1/06; B01D 21/24; B01D 21/28; B01D 21/32; B06B 1/06

(52) U.S. Cl. CPC C12H 1/06; B01D 21/2444; B01D 21/283; B01D 21/32; B06B 1/0633

(57) ABSTRACT

Systems and methods for separating yeast cells from alcoholic beverages post-fermentation, through acoustophoresis facilitated by piezoelectric transducers. The system creates controlled acoustic pressures, disrupting the yeast cells effectively and thus enhancing the clarity and quality of the beverage without compromising its flavor profile. This improvement is particularly significant in maintaining the original taste of the beverage while ensuring high operational efficiency.

### CROSS-REFERENCE TO RELATED APPLICATIONS

This application claims the benefit of priority to U.S. Provisional Application No. 63/705,340, filed on Oct. 9, 2024, which is hereby incorporated by reference in its entirety.

### FIELD

The present invention relates generally to systems, tools and methods to kill and separate yeast and/or bacteria in a beverage.

### BACKGROUND

In the production of alcoholic beverages, especially after fermentation, the removal of yeast is essential to ensure the clarity of the product and to preserve its flavor integrity. Traditional yeast removal methods, such as mechanical filtration and chemical treatments, can sometimes alter the natural flavor of the beverage and typically require considerable time.

### SUMMARY

The systems and methods described herein provide for separating yeast from alcoholic beverages during production. In some embodiments, the separation may be performed on non-alcoholic beverages or other liquid media. In some embodiments, the system may comprise a fermentation tank, an acoustophoresis tank and a control electronics unit.

In some embodiments, the fermentation tank may be configured to receive one or more fermentable ingredients and produce, through fermentation of the one or more fermentable ingredients, an alcoholic beverage.

In some embodiments, the acoustophoresis tank may be separate from the fermentation tanks. The acoustophoresis tank may comprise one or more piezoelectric transducers integrated with the acoustophoresis tank, the one or more transducers being capable of generating acoustic pressures to disrupt yeast cells within the alcoholic beverage. The acoustophoresis tank may further comprise a control unit coupled to the one or more piezoelectric transducers, wherein the control unit is configured to control operation of the one or more piezoelectric transducers. The acoustophoresis tank my further include a yeast settling tank.

In some embodiments, the acoustophoresis tank may be configured to receive a portion of the alcoholic beverage from the fermentation tank, apply, by the one or more transducers, acoustic pressure to the received portion of the alcoholic beverage and clarify the received portion of the alcoholic beverage. In some embodiments, the clarification process may comprise collecting, in the yeast settling tank, yeast cells disrupted by the acoustic pressure generated by the one or more transducers within the acoustophoresis tank, and wherein the clarification produces a clarified portion of the alcoholic beverage.

In some embodiments, the clarified portion of the alcoholic beverage may be recirculated from the acoustophoresis tank to fermentation tank. The clarified portion of the alcoholic beverage may be combined with the alcoholic beverage remaining in the fermentation tank to produce a filtered alcoholic beverage.

In some embodiments, the control unit may determine a level of clarity of the filtered alcoholic beverage and based on the determined level of clarity of the filtered alcoholic beverage, perform an additional clarification process. In some embodiments, the clarification process may be halted when the determined level of clarity is equal to or greater than a predetermined threshold.

In some embodiments, the one or more piezoelectric transducers integrated into the acoustophoresis tank may include internal piezoelectric tubes, wherein the piezoelectric tubes are configured to generate acoustic standing waves that facilitate disruption of yeast cells.

In some embodiments, the one or more piezoelectric transducers integrated into the acoustophoresis tank may include external linear acoustic transducers configured to induce acoustic standing waves within the acoustophoresis tank for disrupting yeast cells.

In some embodiments, the acoustic standing waves may be generated as sine waves at a frequency between 60 kHz and 80 kHz and the acoustic pressure at wave nodes of the acoustic standing waves may be greater than 200 MPa.

The appended claims may also serve as a summary of this application.

The features and components of these embodiments will be described in further detail in the description which follows. Additional features and advantages will also be set forth in the description which follows, and in part will be implicit from the description, or may be learned by the practice of the embodiments. The detailed description and specific examples are intended for illustration only and are not intended to limit the scope of the disclosure.

### BRIEF DESCRIPTION OF THE DRAWINGS

The present disclosure will become better understood from the detailed description and the drawings, wherein:

FIG. 1 is a diagram illustrating a yeast separation system in which some embodiments may operate.

FIG. 2A is a diagram illustrating an exemplary fermentation tank in accordance with aspects of the present disclosure.

FIG. 2B is a diagram illustrating an exemplary control electronics unit in accordance with aspects of the present disclosure.

FIG. 2C is a diagram illustrating an exemplary yeast separator/acoustophoresis tank in accordance with aspects of the present disclosure.

FIG. 2D is a diagram illustrating an exemplary server in accordance with aspects of the present disclosure.

FIG. 3 is a diagram illustrating acoustic standing waves generated within an acoustophoresis tank in accordance with some embodiments.

FIG. 4A is a diagram illustrating a yeast separation system with an acoustophoresis tank equipped with internal piezoelectric tubes in accordance with some embodiments.

FIG. 4B is a diagram illustrating a yeast separation system with an acoustophoresis tank equipped with external linear acoustic transducers in accordance with some embodiments.

FIG. 5 is a flow chart illustrating an exemplary method that may be performed in accordance with some embodiments.

FIG. 6 is a diagram illustrating an exemplary computer/control system that may perform processing in some embodiments and in accordance with aspects of the present disclosure.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments, however it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

The following generally relates to a system and methods for the separation of yeast, bacteria or other microbial life from liquids. The separation process may also include deactivation, inactivation, sterilization and/or disinfection of one or more microbes within the liquid being processed.

In some embodiments, the system may be configured to utilize acoustophoresis, facilitated by piezoelectric transducers, to separate yeast cells from alcoholic beverages post-fermentation. The system may be configured to create controlled acoustic pressures, disrupting the yeast cells effectively and thus enhancing the clarity and quality of the beverage without compromising its flavor profile. This improvement is particularly significant in maintaining the original taste of the beverage while ensuring high operational efficiency.

This method not only improves separation efficiency but also preserves the quality of the beverage, offering a significant advantage over traditional methods.

In some embodiments, the fluid from a brew/fermentation tank may be transferred to either a tank or a wide tube (separator unit/acoustophoresis tank) equipped with acoustic transducers that are either inserted or attached externally. The control electronics may activate the piezoelectric transducers to produce a standing wave. At the wave nodes, the extreme pressure, such as 200 MPa, may be applied to crush the yeast cell walls. The deactivated yeast cells may then settle by gravity and may be collected in a yeast settling tank. The now clarified brew may be subsequently pumped back into the brew/fermentation tank. The yeast settling tank may be attached to, or a part of, the separator unit/acoustophoresis tank.

In some embodiments, the piezoelectric tubes may be positioned inside the tank where acoustophoresis occurs, and the disrupted yeast may collect at the tank's bottom (yeast settling tank). In some embodiments, the piezoelectric transducers may be mounted externally around the chamber where acoustophoresis occurs, with the standing waves created inside the chamber aiding in yeast sedimentation at the bottom. In both configurations, the piping for the beverage may be strategically angled to prevent any sedimented yeast from entering the brew/fermentation tank's intake.

In some embodiments, the piezoelectric transducers may be configured to produce a 74 kHz sine wave for intervals of 10 and 20 minutes. In some embodiments, the wave may be produced at a higher or lower frequency and at different duration and intervals.

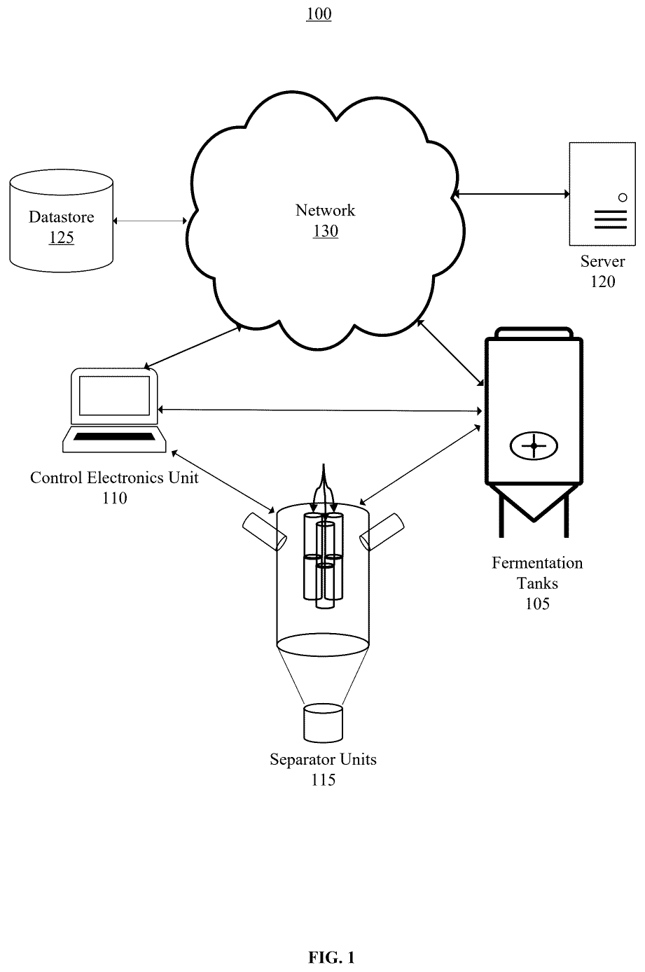

FIG. 1 is a diagram illustrating an exemplary acoustic yeast separation system 100 in which some embodiments may operate. The acoustic yeast separation system 100 may comprise one or more fermentation tanks 105, one or more control electronics units 110, one or more separator units 115, one or more servers 120, one or more datastores 125 and one or more networks 130.

The one or more fermentation tanks 105 may be in communication with the one or more control electronics units 110, one or more separator units 115, one or more servers 120 and one or more datastores 125 through network 130. In some embodiments, the fermentation tanks 105, separator units 115 and control electronics units may communicate directly with one another. The direct communication may be performed wirelessly or through a wired connection.

The one or more fermentation tanks 105 may be any standard brewing tank. In some embodiments, the fermentation tanks 105 may be conical fermenters, unitanks, brite tanks, barrels, casks, or other types of fermentation/aging vessels. In some embodiments, the fermentation tanks may be temperature controlled and/or pressurized. The fermentation tank 105 may be physically connected to a specialized acoustophoresis tank (separator unit 115) equipped with piezoelectric transducers. The connection may be via one or more tubes, pipes, valves or combination thereof.

The control electronics units 110 may be one or more physical or virtual machines configured to communicate with the one or more fermentation tanks 105, one or more separator units 115, one or more servers 120 and the one or more datastores 125. In some embodiments, the control electronics units 110 may include microcontrollers and processors configured to monitor and control the operation of the fermentation tanks 105 and separator units 115.

In some embodiments, the control electronics units 110 may be configured to control the operation of the fermentation tanks 105 and separator units 115. The control electronics may be configured to control the temperature and pressure of the fermentation tanks 105 and separator 115. In some embodiments, the control electronics units 110 may be configured to control the flow of liquid media/fermented beverage from the fermenter tanks 105 through the separator unit 115 and back to the fermentation tanks 105. In some embodiments, the control electronics units 110 may further be configured to control one or more piezoelectric transducers of the separator unit 115. The controlling of the piezoelectric transducers may include setting or adjusting the timing, duration, frequency, shape and/or magnitude of the standing wave produced by the transducer.

The one or more separator units 115 may comprise one or more acoustic transducers, one or more pumps, or more fluid return channels, one or more valves and a settling tank.

The one or more pumps may be pumps configured for a single purpose, such as for recirculating the fluid from the separator units 115 back into the fermentation tanks 110. In some embodiments, the pumps may be of the same type or model, but configured to perform different functions, such as recirculating, generating whirlpools for separation of solids from the liquid, agitation, or combination thereof. In some embodiments, there may be one or more types/models of pumps incorporated within the separator units 115 or inline with the separator units. There may be one or more pumps of each of the one or more types/models of pumps, and each pump may be configured independently.

In some embodiments, the transducers may be controlled by control electronics units 105 to generate precise acoustic standing waves. At the nodes of these waves, the generated pressures may be sufficient to disrupt the cell walls of yeast/bacteria, facilitating the sedimentation of the cells in a designated yeast settling tank located beneath the acoustophoresis chamber. Following this process, the clarified beverage may be recirculated back into the brewing tank for further refinement or packaging.

In some embodiments, the transducers may be internal, external or combination thereof. The transducers, pumps, tubes, valves and other components of the separator units 115 may be organized in a manner which optimizes yeast sedimentation and minimizes contamination risks during the recirculation process.

The servers 120 may be one or more physical or virtual machines configured to communicate with the one or more fermentation tanks 105, one or more control electronics units 110, one or more separator units 115 and one or more datastores 125. The one or more servers 120 may be configured as a distributed computing infrastructure. The servers 120 may be the same or separate devices from that of control electronics unit 110. Servers 120 may be configured to communicate with fermentation tanks 105 and separator units 115 either directly or indirectly through control electronics unit 110. The communication may include the receiving of sensor data and status information as well as transmission of control commands.

Datastores 125 may communicate with one another over network 130. Datastores 125 may be any storage device capable of storing data for processing or as a result of processing information at the fermentation tanks 105, control electronics units 110, separator units 115, and/or servers 120. The datastores 125 may be a separate device or the same device as control electronics unit 110 or server 120. The datastores 125 may be located in the same location as that of control electronics units 110 and/or servers 120, or at separate locations.

Network 130 may be an intranet, internet, mesh, LTE, GSM, peer-to-peer or other communication network that allows the one or more control electronics units 110 and one or more servers 120 to communicate with the one or more fermentation tanks 105, one or more separator units 115 and datastores 125.

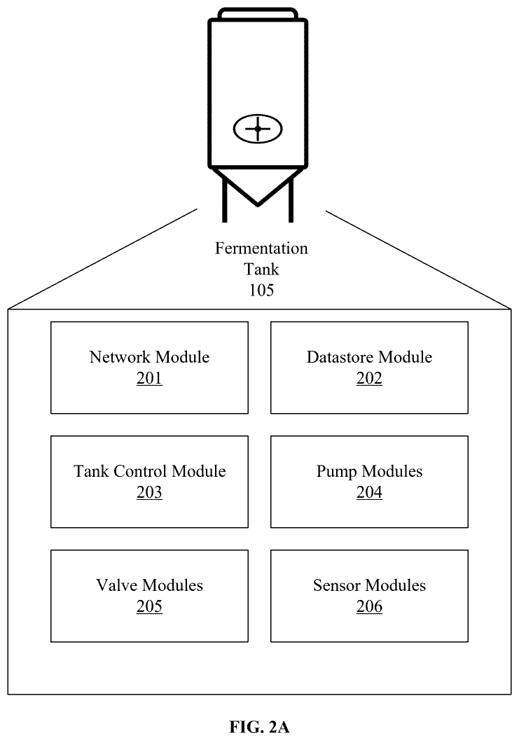

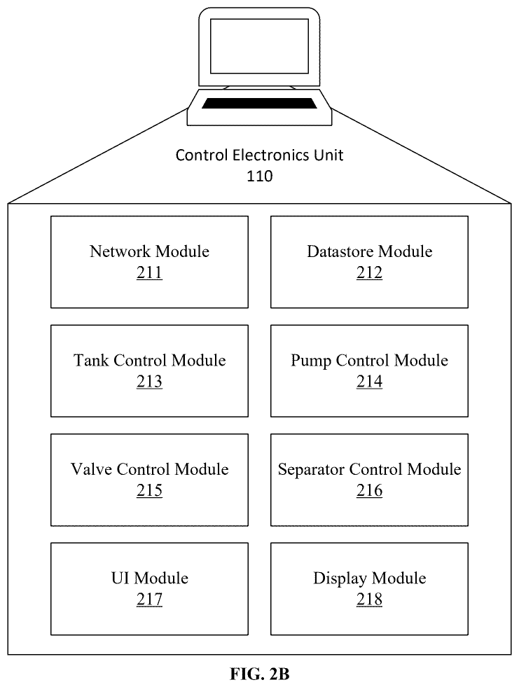

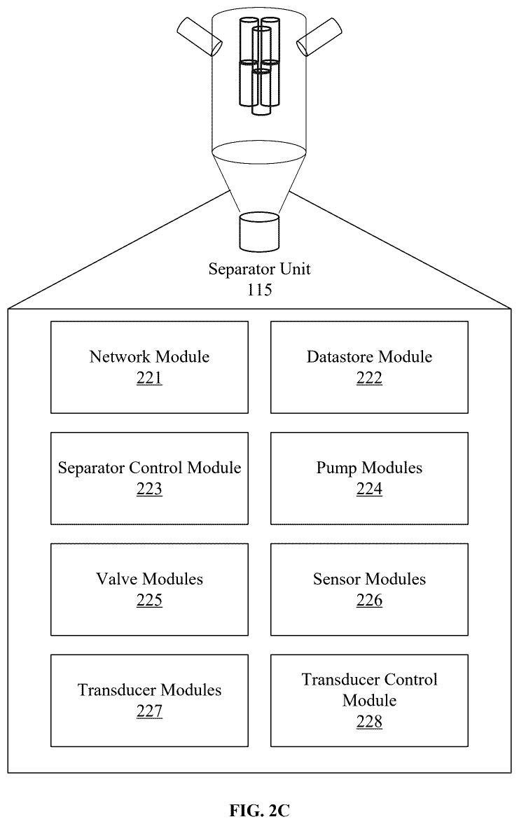

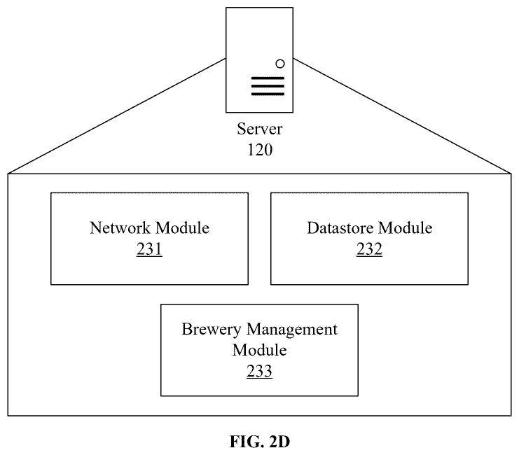

FIG. 2A is a diagram illustrating an exemplary fermentation tank 105 in accordance with aspects of the present disclosure. Fermentation tank 105 may comprise network module 201, datastore module 202, tank control module 203, one or more pump modules 204, one or more valve modules 205 and one or more sensor modules 206.

Network module 201 may transmit and receive data from other computing systems via a network such as network 130 as described above with regard to FIG. 1. In some embodiments, the network module 201 may enable transmitting and receiving data from the Internet, Intranet, peer-to-peer network, ad hoc network or other forms of communication. Data received by the network module 201 may be used by the other modules. The modules may transmit data through the network module 201.

The datastore module 202 may be configured to store information generated by the one or more modules operating on the fermentation tank 105. The one or more modules operating on fermentation tank may also retrieve information from the datastore module 202. Datastore module 202 may also be configured to receive and store information received over network module 201.

Tank control module 203 may be configured to control operation of the fermentation tank based on commands received from control electronics units 110 and/or server 120. The tank control module 203 may be configured to turn on and off the pump modules 204, adjust the flow rate and pressure generated by the pump modules 204 or other operational parameters of the pump. The tank control module 203 may also be configured to control the opening and closing of one or more valve modules 205. Control of the pump modules 204 and valve modules 205 may be based on predetermined commands and/or based on sensor data captured by sensor modules 206. In some embodiments, the tank control module 203 may also be configured to control heating and cooling units connected to the fermentation tank. The heating and cooling units may be used to maintain a stable temperature of the fermentation tank 105. In some embodiments, the tank control module 203 may be configured to reduce the temperature of the fermented beverage/liquid media in a rapid manner, to facilitate crashing of sediment out of the liquid.

Pump modules 204 may be any pump capable of transferring liquids. In some embodiments, the pump modules may be configured to handle sediment and slurries.

Valve modules 205 may be any electronically controlled/actuated valves. In some embodiments, a combination of electronically controlled valves and manual valves may be used in the fermentation tanks 105.

Sensor modules 206 may be configured to measure and record temperature, pressure, flow and specific gravity of the liquid media. In some embodiments, the sensor modules 206 may also include cameras, lasers and LED light sources.

FIG. 2B is a diagram illustrating an exemplary control electronics unit 110 in accordance with aspects of the present disclosure. Control electronics unit 110 may comprise network module 211, datastore module 212, tank control module 213, pump control module 214, valve control module 215, separator control module 216, UI module 217 and display module 218.

Network module 211 and datastore module 212 may be the same or similar to that of network module 201 and datastore module 202 as described above with regard to FIG. 2A.

In some embodiments, tank control module 213 may be used in place of tank control module 203 of FIG. 2A. In some embodiments, tank control module 213 may be used in combination with tank control module 203 of FIG. 2A. Tank control module 213 may operate in the same manner as described with regard to tank control module 203 in FIG. 2A.

Pump control module 214 may be configured to control one or more pumps in the system. The one or more pumps may be pumps within or connected to fermentation tanks 105 and separator units 115. Additional pumps in the system may also be controlled by the pump control module 214.

Valve control module 215 may be configured to control one or more valves in the system. The one or more valves may be valves within or connected to fermentation tanks 105 and separator units 115. Additional valves in the system may also be controlled by the valve control module 215.

Separator control module 216 may be used in place of separator control module 223 of FIG. 2C. In some embodiments, separator control module 216 may be used in combination with separator control module 223 of FIG. 2C. Separator control module 216 may operate in the same manner as described below with regard to separator control module 223 in FIG. 2C.

UI module 217 may be configured to generate an interface/visual representation of a brewery/winery or other fermented beverage facility. The visual representation may include fermentation tanks 105, control electronics units 110 and separator units 115 and well as data from their associated sensors, pumps, valves and transducers. The UI module 217 may be configured to receive input from a user corresponding to commands to be performed and/or parameters to be set.

Display module 218 may be configured to display the interface generated by the UI module 217. The display module 218 may be an LCD, LED or other screen capable of displaying graphical data. In some embodiments, the display module 218 may also be a touch screen display.

FIG. 2C is a diagram illustrating an exemplary separator unit 115 in accordance with aspects of the present disclosure. Separator unit 115 may comprise network module 221, datastore module 222, separator control module 223, one or more pump modules 224, one or more valve modules 225, one or more sensor modules 226, one or more transducer modules 227 and a transducer control module 228.

Network module 221 and datastore module 222 may be the same or similar to that of network module 201 and datastore module 202 as described above with regard to FIG. 2A.

Separator control module 223 may be configured to control operation of the separator unit 115 based on commands received from control electronics units 110 and/or server 120. The separator control module 223 may be configured to turn on and off the pump modules 224, adjust the flow rate and pressure generated by the pump modules 224 or other operational parameters of the pump. The separator control module 223 may also be configured to control the opening and closing of one or more valve modules 225. Control of the pump modules 224 and valve modules 225 may be based on predetermined commands and/or based on sensor data captured by sensor modules 226. In some embodiments, the separator control module 223 may be configured to coordinate with transducer control module 228 to facilitate control of the transducer modules 227.

Pump modules 224, valve modules 225 and sensor modules 226 may be the same or similar to that of pump modules 204, valve modules 205 and sensor modules 206 as described above with regard to FIG. 2A.

The transducer modules 227 may be configured to generate high-frequency acoustic pressures. In some embodiments, the transducer modules 227 may be piezoelectric transducers. The transducer modules may be lead zirconate titanate (PZT), barium titanate (BaTiO3), lithium niobate (LiNbO3), Rochelle salt, quartz crystals as well as other ceramics, polymers and natural materials. The transducers may be linear transducers or tube transducers. In some embodiments, the one or more transducer tubes may be operated together or independently. The transducer tubes may be connected for flow though in parallel, in series or combinations thereof.

In some embodiments, the transducer modules 227 may be configured to function within the kHz to MHz frequency range and generate pressures up to 200 MPa, which are effective in lysing yeast cells. In some embodiments, the pressure may be above 200 MPa. In some embodiments, the transducer modules 227 may be configured to operate together or independently at discrete frequencies between 1 kHz and 20 Mhz.

Transducer control module 228 may be configured to control the operation of the one or more transducer modules 227. The transducer control module 228 may adjust the voltage and current to each of the transducer modules 227 individually or in groups. In some embodiments, the transducer control module 228 may be configured to adjust the timing, duration, magnitude, shape, frequency and/or other parameters of the transducers/standing waves based on sensor readings and/or commands received from the separator control module 223, control electronics units 105 and/or servers 120.

FIG. 2D is a diagram illustrating an exemplary sever 120 in accordance with aspects of the present disclosure. Server 120 may comprise network module 231, datastore module 232 and brewery management module 233.

Network module 231 and datastore module 232 may be the same or similar to that of network module 201 and datastore module 202 as described above with regard to FIG. 2A.

Brewery management module 233 may be configured to manage inventory, production schedules, mash bills/recipes, and any equipment in a brewery or winery. Commands may be sent from the brewery management module 233 to the control electronics units 110 to facilitate brewing of the beverages.

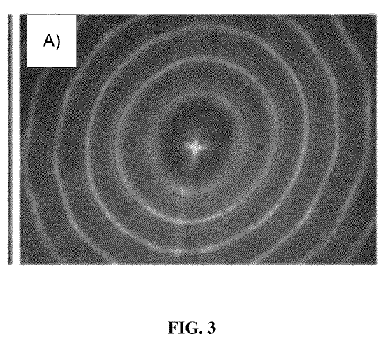

FIG. 3 is a diagram illustrating acoustic standing waves generated within an acoustophoresis tank, such as the separator unit 115 of FIG. 1, as described with regard to FIG. 2C, in accordance with some embodiments. This illustration demonstrates how the acoustic frequency applied by piezoelectric transducers creates pressure nodes and antinodes, crucial for the disruption of yeast cells within the alcoholic beverage. In some embodiments, a laser light may be passed through the tube or regions of the separator while an electrical pulse is applied to the one or more transducers. The acoustic waves generated by the transducers may be illuminated by the laser light and projected onto a grid. One or more cameras and/or other sensors may be configured to capture images of the projected light. The captured images may be analyzed to determine efficacy of the acoustic standing way. An amount of separation and/or density of cells/particles may be determined based on the captured images. The system may be configured to adjust a magnitude, frequency, shape or other characteristics of the acoustic wave based on the analysis of the images. In some embodiments, the dwell time of the beverage in the tube may be adjusted based on the determined efficacy of the acoustic wave.

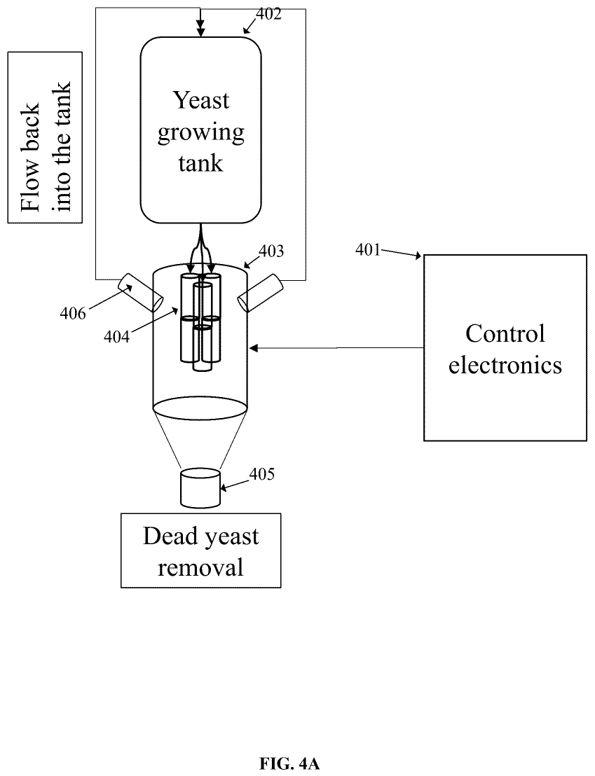

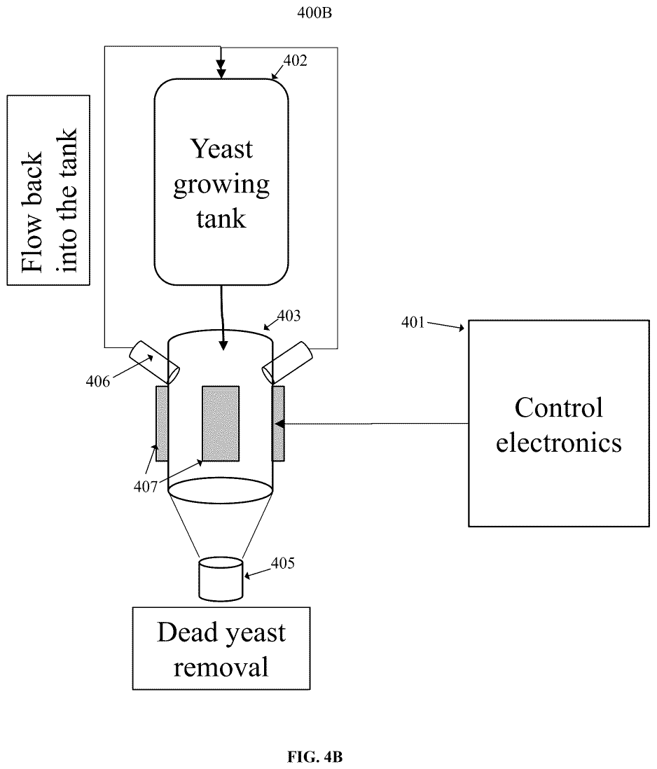

FIG. 4A is a diagram illustrating a yeast separation system 400A in accordance with some embodiments. The yeast separation system 400A may comprise control electronics 401, a yeast growing tank 402, an acoustophoresis tank 403 and a recirculation system 406.

In some embodiments, the acoustophoresis tank 403 may further comprise one or more piezoelectric transducer tubes 404 and a settling tank 405.

In some embodiments, the yeast separation system 400A may be configured to transfer liquid media from the yeast growing tank 402 into the acoustophoresis tank 403. The transfer may be controlled by control electronics 401. The transfer may be gravity assisted, such as through direct draining or through a siphoning mechanism. In some embodiments, one or more pumps may be used to perform the transfer and recirculation between the yeast growing tank 402 and the acoustophoresis tank 403. In some embodiments, a combination of pump driven and gravity assisted methods may be used to facilitate the transfer and recirculation.

In some embodiments, the liquid media may be transferred/recirculated between the yeast growing tank 402 and the acoustophoresis tank 403 through rigid or flexibly tubes/pipes.

In some embodiments, the liquid media may be forced to flow through the one or more transducer tubes 404. The transducer tubes 404 may be internal to the acoustophoresis tank 403 and configured to produce standing waves through the liquid media as it is forced through.

The settling tank 405 may be configured to collect and/or remove sediment, inactive/dead yeast/bacteria (lees), trub, or other particles in the liquid media. The settling tank 405 may further comprise one or more valves and tubes configured to remove the sediment.

The recirculation system 406 may comprise one or more valves and/or pipes/tubes configured to return liquid media back to the yeast growing tank 402. In some embodiments, the recirculation system may be angled downward to reduce the recirculation of sediment. In some embodiments, the recirculation system 406 may be positioned at other locations, such as above the point of entry of the liquid media. In some embodiments, the recirculation system 406 may further comprise baffles to reduce recirculation of trub/lees.

The liquid media may be recirculated until a desired clarity of the liquid media is achieved. In some embodiments, the liquid media may be circulated at predetermined times and for predetermined durations. The times and duration may be set by the user or based on analysis of one or more sensors. The sensors may include thermometers, cameras, flow sensors, pressure sensors, CO2 sensors, hydrometers, refractometers or combination thereof.

FIG. 4B is a diagram illustrating a yeast separation system 400B in accordance with some embodiments. The yeast separation system 400B may comprise control electronics 401, a yeast growing tank 402, an acoustophoresis tank 403, a settling tank 405, a recirculation system 406 and external linear acoustic transducers 407 (LATs).

In some embodiments, the operation of the separation system 400B may be similar to that of system 400A as described in FIG. 4A. In some embodiments, the LATs may be positioned around the exterior of the acoustophoresis tank 403. The LATs may be configured to induce standing waves across the fluid medium to disrupt yeast cells effectively.

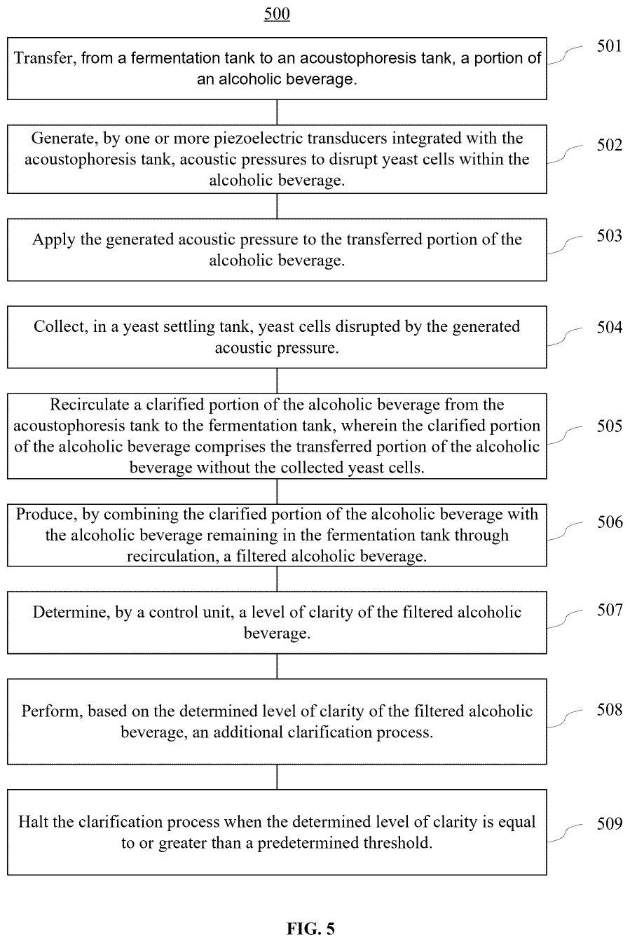

FIG. 5 is a flow chart illustrating an exemplary process flow 500 that may be performed in accordance with some embodiments.

At step 501, the yeast separation system may be configured to transfer, from a fermentation tank to an acoustophoresis tank, a portion of an alcoholic beverage.

At step 502, the system may be configured to generate, by one or more piezoelectric transducers integrated with the acoustophoresis tank, acoustic pressures to disrupt yeast cells within the alcoholic beverage.

At step 503, the system may be configured to apply the generated acoustic pressure to the transferred portion of the alcoholic beverage.

At step 504, the system may be configured to collect, in a yeast settling tank, yeast cells disrupted by the generated acoustic pressure.

At step 505, the system may be configured to recirculate a clarified portion of the alcoholic beverage from the yeast settling tank or acoustophoresis tank to the fermentation tank, wherein the clarified portion of the alcoholic beverage comprises the transferred portion of the alcoholic beverage without the collected yeast cells.

At step 506, the system may be configured to produce, by combining the clarified portion of the alcoholic beverage with the alcoholic beverage remaining in the fermentation tank through recirculation, a filtered alcoholic beverage.

At step 507, the system may be configured to determine, by a control unit, a level of clarity of the filtered alcoholic beverage.

At step 508, the system may be configured to perform, based on the determined level of clarity of the filtered alcoholic beverage, an additional clarification process.

At step 509, the system may be configured to halt the clarification process when the determined level of clarity is equal to or greater than a predetermined threshold.

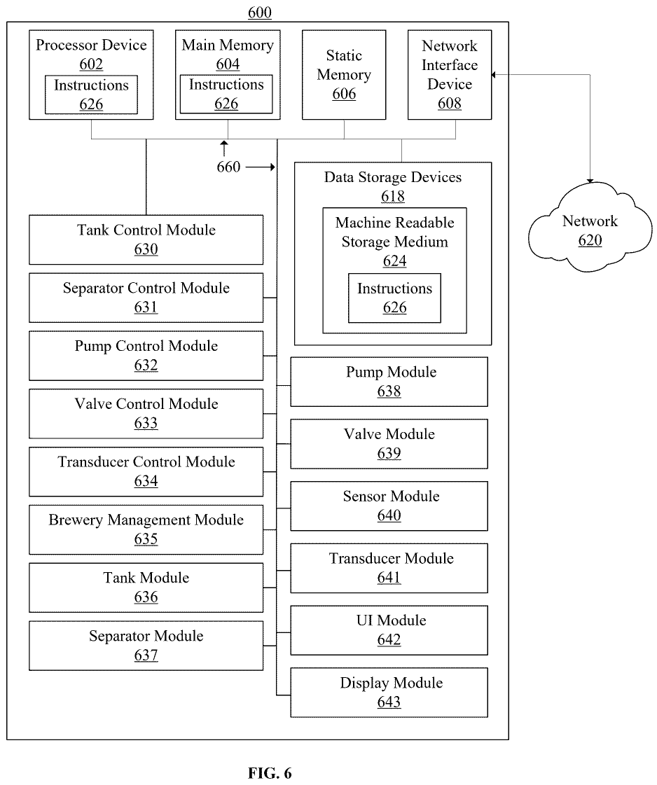

FIG. 6 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, an ad-hoc network, a mesh network, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 600 includes a processing device 602, a main memory 604 (e.g., read-only memory (ROM), flash memory, dynamic random access memory (DRAM) such as synchronous DRAM (SDRAM) or Rambus DRAM (RDRAM), etc.), a static memory 606 (e.g., flash memory, static random access memory (SRAM), etc.), and a data storage device 618, which communicate with each other via a bus 660.

Processing device 602 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. The processing device 602 is configured to execute instructions 626 for performing the operations and steps discussed herein.

The computer system 600 may further include a network interface device 608 to communicate over the network 620. The computer system 600 may also include a tank control module 630, separator control module 631, pump control module 632, valve control module 633, transducer control module 634, brewery management module 635, tank module 636, separator module 637, pump module 638, valve module 639, sensor module 640, transducer module 641, UI module 642 and display module 643.

Tank control module 630, separator control module 631, pump control module 632, valve control module 633, transducer control module 634, brewery management module 635, tank module 636, separator module 637, pump module 638, valve module 639, sensor module 640, transducer module 641, UI module 642 and display module 643 may be the same or similar to that of tank control module 203/213, separator control module 216/223, pump control module 214, valve control module 215, transducer control module 228, brewery management module 233, fermentation tank 105, separator unit 115, pump module 204/224, valve module 205/225, sensor module 206/226, transducer module 227, UI module 217 and display module 218 as disclosed in FIGS. 2A-2D.

The data storage device 618 may include a machine-readable storage medium 624 (also known as a computer-readable medium) on which is stored one or more sets of instructions or software 626 embodying any one or more of the methodologies or functions described herein. The instructions 626 may also reside, completely or at least partially, within the main memory 604 and/or within the processing device 602 during execution thereof by the computer system 600, the main memory 604 and the processing device 602 also constituting machine-readable storage media. Information, including data used in the processes and methods of the system and the one or more sets of instructions or software, may also be stored in blockchain, as NFTs or other decentralized technologies.

In one implementation, the instructions 626 include instructions to implement functionality corresponding to the components of a device to perform the disclosure herein. While the machine-readable storage medium 624 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

It will be appreciated that the present disclosure may include any one and up to all of the following examples.

### Example 1

A system for separating yeast, during production, from alcoholic beverages, the system comprising: a fermentation tank configured to: receive one or more fermentable ingredients; and produce, through fermentation of the one or more fermentable ingredients, an alcoholic beverage; and an acoustophoresis tank, wherein the acoustophoresis tank is separate from the fermentation tanks, and wherein the acoustophoresis tank comprises: one or more piezoelectric transducers integrated with the acoustophoresis tank, the one or more transducers being capable of generating acoustic pressures to disrupt yeast cells within the alcoholic beverage; a control unit coupled to the one or more piezoelectric transducers, wherein the control unit is configured to control operation of the one or more piezoelectric transducers; and a yeast settling tank coupled to the acoustophoresis tank; and wherein the acoustophoresis tank is configured to: receive a portion of the alcoholic beverage from the fermentation tank; apply, by the one or more transducers, acoustic pressure to the received portion of the alcoholic beverage; clarify the received portion of the alcoholic beverage, wherein the clarification process comprises: collecting, in the yeast settling tank, yeast cells disrupted by the acoustic pressure generated by the one or more transducers within the acoustophoresis tank, and wherein the clarification produces a clarified portion of the alcoholic beverage; recirculating the clarified portion of the alcoholic beverage from the acoustophoresis tank to fermentation tank; and producing, by combining the clarified portion of the alcoholic beverage with the alcoholic beverage remaining in the fermentation tank, a filtered alcoholic beverage; determining, by the control unit, a level of clarity of the filtered alcoholic beverage; performing, based on the determined level of clarity of the filtered alcoholic beverage, an additional clarification process; and halting the clarification process when the determined level of clarity is equal to or greater than a predetermined threshold.

### Example 2

The system of Example 1, wherein the one or more piezoelectric transducers integrated into the acoustophoresis tank includes internal piezoelectric tubes, wherein the piezoelectric tubes are configured to generate acoustic standing waves that facilitate disruption of yeast cells.

### Example 3

The system of any one of Examples 1-2, wherein the one or more piezoelectric transducers integrated into the acoustophoresis tank includes external linear acoustic transducers configured to induce acoustic standing waves within the acoustophoresis tank for disrupting yeast cells.

### Example 4

The system of any one of Examples 1-3, wherein the acoustic standing waves are generated by a sine wave at a frequency between 60 kHz and 80 kHz and wherein the acoustic pressure at wave nodes of the acoustic standing waves is greater than 200 MPa.

### Example 5

A method for separating yeast from alcoholic beverages during production, wherein the method is configured to: transfer, from a fermentation tank to an acoustophoresis tank, a portion of the alcoholic beverage; generate, by one or more piezoelectric transducers integrated with the acoustophoresis tank, acoustic pressures to disrupt yeast cells within the alcoholic beverage; clarify the transferred portion of the alcoholic beverage, wherein the clarification process comprises: applying the generated acoustic pressure to the transferred portion of the alcoholic beverage; collecting, in a yeast settling tank, yeast cells disrupted by the generated acoustic pressure; and recirculating a clarified portion of the alcoholic beverage from the acoustophoresis tank to the fermentation tank, wherein the clarified portion of the alcoholic beverage comprises the transferred portion of the alcoholic beverage without the collected yeast cells.

### Example 6

The method of Example 5, wherein the acoustophoresis tank is separate from the fermentation tank.

### Example 7

The method of any one of Examples 5-6, wherein the generating of the acoustic pressures by the one or more piezoelectric transducers is based on one or more signals from a control unit.

### Example 8

The method of any one of Examples 5-7, wherein the one or more piezoelectric transducers integrated into the acoustophoresis tank includes internal piezoelectric tubes, wherein the piezoelectric tubes are configured to generate acoustic standing waves that facilitate disruption of yeast cells.

### Example 9

The method of any one of Examples 5-8, wherein the one or more piezoelectric transducers integrated into the acoustophoresis tank includes external linear acoustic transducers configured to induce acoustic standing waves within the acoustophoresis tank for disrupting yeast cells.

### Example 10

The method of any one of Examples 5-9, wherein the acoustic standing waves are generated by a sine wave at a frequency between 60 kHz and 80 kHz and wherein the acoustic pressure at wave nodes of the acoustic standing waves is greater than 200 MPa.

### Example 11

The method of any one of Examples 5-10, wherein the clarification process further comprises: producing, by combining the clarified portion of the alcoholic beverage with the alcoholic beverage remaining in the fermentation tank through recirculation, a filtered alcoholic beverage; determining, by the control unit, a level of clarity of the filtered alcoholic beverage; performing, based on the determined level of clarity of the filtered alcoholic beverage, an additional clarification process; and halting the clarification process when the determined level of clarity is equal to or greater than a predetermined threshold.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

What is claimed is:

1. A system for separating yeast, during production, from alcoholic beverages, the system comprising:
a fermentation tank configured to:
receive one or more fermentable ingredients; and
produce, through fermentation of the one or more fermentable ingredients, an alcoholic beverage; and
an acoustophoresis tank, wherein the acoustophoresis tank is separate from the fermentation tanks, and wherein the acoustophoresis tank comprises:
one or more piezoelectric transducers integrated with the acoustophoresis tank, the one or more transducers being capable of generating acoustic pressures to disrupt yeast cells within the alcoholic beverage;
a control unit coupled to the one or more piezoelectric transducers, wherein the control unit is configured to control operation of the one or more piezoelectric transducers; and
a yeast settling tank coupled to the acoustophoresis tank; and
wherein the acoustophoresis tank is configured to:
receive a portion of the alcoholic beverage from the fermentation tank;
apply, by the one or more transducers, acoustic pressure to the received portion of the alcoholic beverage;
clarify the received portion of the alcoholic beverage, wherein the clarification process comprises:
collecting, in the yeast settling tank, yeast cells disrupted by the acoustic pressure generated by the one or more transducers within the acoustophoresis tank, and wherein the clarification produces a clarified portion of the alcoholic beverage;
recirculating the clarified portion of the alcoholic beverage from the acoustophoresis tank to fermentation tank; and
producing, by combining the clarified portion of the alcoholic beverage with the alcoholic beverage remaining in the fermentation tank, a filtered alcoholic beverage;
determining, by the control unit, a level of clarity of the filtered alcoholic beverage;
performing, based on the determined level of clarity of the filtered alcoholic beverage, an additional clarification process; and
halting the clarification process when the determined level of clarity is equal to or greater than a predetermined threshold.

2. The system of claim 1, wherein the one or more piezoelectric transducers integrated into the acoustophoresis tank includes internal piezoelectric tubes, wherein the piezoelectric tubes are configured to generate acoustic standing waves that facilitate disruption of yeast cells.

3. The system of claim 1, wherein the one or more piezoelectric transducers integrated into the acoustophoresis tank includes external linear acoustic transducers configured to induce acoustic standing waves within the acoustophoresis tank for disrupting yeast cells.

4. The system of claim 2, wherein the acoustic standing waves are generated by a sine wave at a frequency between 60 kHz and 80 kHz and wherein the acoustic pressure at wave nodes of the acoustic standing waves is greater than 200 MPa.

5. A method for separating yeast from alcoholic beverages during production, wherein the method is configured to:
transfer, from a fermentation tank to an acoustophoresis tank, a portion of the alcoholic beverage;
generate, by one or more piezoelectric transducers integrated with the acoustophoresis tank, acoustic pressures to disrupt yeast cells within the alcoholic beverage;
clarify the transferred portion of the alcoholic beverage, wherein the clarification process comprises:
applying the generated acoustic pressure to the transferred portion of the alcoholic beverage;
collecting, in a yeast settling tank, yeast cells disrupted by the generated acoustic pressure; and
recirculating a clarified portion of the alcoholic beverage from the acoustophoresis tank to the fermentation tank, wherein the clarified portion of the alcoholic beverage comprises the transferred portion of the alcoholic beverage without the collected yeast cells.

6. The method of claim 5, wherein the acoustophoresis tank is separate from the fermentation tank.

7. The method of claim 6, wherein the generating of the acoustic pressures by the one or more piezoelectric transducers is based on one or more signals from a control unit.

8. The method of claim 7, wherein the one or more piezoelectric transducers integrated into the acoustophoresis tank includes internal piezoelectric tubes, wherein the piezoelectric tubes are configured to generate acoustic standing waves that facilitate disruption of yeast cells.

9. The method of claim 7, wherein the one or more piezoelectric transducers integrated into the acoustophoresis tank includes external linear acoustic transducers configured to induce acoustic standing waves within the acoustophoresis tank for disrupting yeast cells.

10. The method of claim 9, wherein the acoustic standing waves are generated by a sine wave at a frequency between 60 kHz and 80 kHz and wherein the acoustic pressure at wave nodes of the acoustic standing waves is greater than 200 MPa.

11. The method of claim 10, wherein the clarification process further comprises:
producing, by combining the clarified portion of the alcoholic beverage with the alcoholic beverage remaining in the fermentation tank through recirculation, a filtered alcoholic beverage;
determining, by the control unit, a level of clarity of the filtered alcoholic beverage;
performing, based on the determined level of clarity of the filtered alcoholic beverage, an additional clarification process; and
halting the clarification process when the determined level of clarity is equal to or greater than a predetermined threshold.
